(19) United States
(12) Patent Application Publication
(10) Pub. No.: US 2020/0356765 A1
(43) Pub. Date: Nov. 12, 2020

(54) SOLVING MAGNETIC INTERFERENCE IN INERTIAL SENSORS

(71) Applicant: Ssam Sports, Inc., Allendale, NJ (US)

(72) Inventors: Sang J. Kim, Allendale, NJ (US); Laszlo Kustra, Budapest (HU)

(21) Appl. No.: 15/929,528

(22) Filed: May 7, 2020

Related U.S. Application Data
(60) Provisional application No. 62/931,607, filed on Nov. 6, 2019.
(60) Provisional application No. 62/845,166, filed on May 8, 2019.

(51) Int. Cl. G06K 9/00; G06K 9/62; G06F 3/01

(52) U.S. Cl. CPC G06K 9/00342; G06K 2209/40; G06F 3/011; G06K 9/623

(57) ABSTRACT

A processing device provides a plurality of motion capture sensors affixed to different portions of a subject and establishes, without using a magnetometer, a common reference frame for the plurality of motion capture sensors. The processing device further receives, from the plurality of motion capture sensors, 3D motion capture data corresponding to a movement of the subject and interprets, using the common reference frame, the 3D motion capture data from the plurality of motion capture sensors to represent the movement of the subject.

This application claims the benefit of U.S. Provisional Patent Application No. 62,845,166, filed May 8, 2019 and of U.S. Provisional Patent Application No. 62/931,607, filed Nov. 6, 2019, the entire contents of each of which are hereby incorporated by reference herein.

### TECHNICAL FIELD

The present disclosure is generally related to computer systems, and is more specifically related to systems and methods for solving magnetic interference in inertial sensors.

### BACKGROUND

Three dimensional (3D) motion visualization and data is used to analyze human motion in sports and health applications. 3D systems can provide useful information of angles, speed, etc. which can be used to identify poor movement for performance or health.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 depicts a high-level component diagram of an illustrative system architecture, in accordance with one or more aspects of the present disclosure.

FIG. 2 is a flow diagram illustrating method of solving magnetic interference in inertial sensors in accordance with one or more aspects of the present disclosure.

FIG. 3 is a flow diagram illustrating method of generating a common reference frame for an array of inertial sensors in accordance with one or more aspects of the present disclosure.

FIGS. 4A-4C are block diagrams illustrating the generating a common reference frame for an array of inertial sensors without using a magnetometer in accordance with one or more aspects of the present disclosure.

FIG. 5 depicts an example computer system which can perform any one or more of the methods described herein, in accordance with one or more aspects of the present disclosure.

### DETAILED DESCRIPTION

Embodiments for solving magnetic interference using inertial sensors are described herein. Inertial sensors are often used in conjunction with 3D motion capture. The inertial sensors typically have an accelerometer, a gyroscope, and a magnetometer (i.e., a compass), among other components. The components work together to capture 3D motion data and provide that data to a computing system for analysis. When a sensor is placed on a person or object to be analyzed, the magnetometer and accelerometer both provide data that is used to understand the orientation of each sensor, relative to one another, in a global reference frame so that the sensor can capture motion of the person or object accurately. In many environments, however, there can be local magnetic interference from nearby machines or metal objects that have become magnetized. This local interference can skew the magnetometer in one or more of the sensors, resulting in incorrect or inaccurate 3D motion capture data.

When capturing human motion, for example, using inertial sensors placed on some or multiple body parts of the person, each sensor can be placed on a bone segment. In some cases multiple segments can be placed on a single bone segment. The subject user is positioned in a known reference position and each sensor records its position and orientation as a reference point in a common, typically Earth-bound, reference frame. In this reference position, the magnetometer, in conjunction with the other sensors, is used to record the orientation of the sensor on the bone segment on which the sensor is placed. Since the body surfaces are not flat geometrical shapes, this process is used to map the current position of each sensor to a known orientation in a useful global reference frame, typically where the axes of the reference frame align with the anteroposterior, mediolateral, and longitudinal directions of the body in the known reference position, for example.

When there is local magnetic interference at the location of an inertial sensor, the magnetometer may send incorrect data to the computing system and the motion capture data may not accurately represent the motion of the subject user or object. Some conventional systems turn off the magnetometer on some or all of the sensors, thereby eliminating the negative effects of local magnetic interference. Furthermore, some sensors do not include a magnetometer at all, although such sensors are typically used independently (i.e., as a single sensor and not part of a sensor array including multiple sensors). An accelerometer and gyroscope alone, however, cannot determine a relative orientation around the vertical axis for multiple sensors in a sensor array. Rather, without the magnetometer, these two components can only determine a change of orientation. Therefore, a way to establish the initial orientation of the sensors at the beginning of the measurement is required. Since the human body is not composed of flat geometric shapes, however, it is virtually impossible to place the sensors in exact orientations on the body. Therefore, the initial orientation is extremely difficult to accurately determine.

Aspects of the present disclosure address the above and other deficiencies by selectively shutting off the magnetometer of all or most of the inertial sensors in a sensor array during an initial calibration routine. In one embodiment, the magnetometer of one inertial sensor can remain enabled during the initial calibration routine. This inertial sensor is generally positioned in the center of the subject user's body, such as on the thorax, for example, because it will be positioned higher above the ground (which is a typical source for magnetic interference) and represents a body part that is relatively vertical, as opposed to an arm or a leg, for example. In other embodiments, none of the inertial sensors in the sensor array have the magnetometer enabled during the initial calibration routine. In such an embodiment, a single sensor in a known position can be used to define a global reference frame.

In one embodiment, during the initial calibration routine, the system performs a known user pose calibration step that maps each inertial sensor to the body part where it is affixed, using approximate known positions of each sensor. For example, the system can receive user input indicating that a first sensor is affixed to the chest of the subject user, a second sensor is affixed to the pelvis of the subject user, etc. More detailed user input can also be received, such as to indicate that the second sensor is affixed to the back side of the pelvis near the sacrum with a particular side of the sensor facing the skin, and with the sensor is pointing in a specific direction (e.g. towards the floor), for example.

Once the data pertaining to the known user pose is received from each inertial sensor equipped with an accelerometer and gyroscope, the computing system is able to determine a relative orientation of each sensor with respect to a global reference frame, which may be different for every sensor, and where one of the axes (e.g., the z-axis) will coincide with the physical up and down (i.e., vertical) direction. This information can be determined from the captured sensor data, such as by applying a Kalman-filter to the accelerometer and gyroscope data. The other two axes (e.g., the x-axis and the y-axis) may be different for multiple sensors placed on other parts of the body, but any sensor's individual reference frame can be rotated into any other sensor's individual reference frame by a rotation around the vertical axis.

In order to transform data from multiple sensors into a common reference frame, in one embodiment, the subject user performs a predefined calibration movement with the sensors placed on their body at certain locations. For example, the user may take a few steps in what the user interprets as the forward direction, or take a few side steps to the left or right. Any movement that lets the system determine a common direction for multiple sensors on the body, based on accelerometer and gyroscope data, can be satisfactory for this purpose.

In one embodiment, the common direction is a 3D vector for each sensor, interpreted in that sensor's individual reference frame that coincides with the same physical direction. When the individual reference frame of two sensors is different, this vector will be numerically different for each sensor. The vector, however, will be perpendicular to the vertical axis, which is shared in common by all sensors. The “down” direction (i.e., along the vertical z-axis) and “common” direction (i.e., in the direction of movement) can be used to determine the third direction (e.g., a 90 degree angle to each of the first two directions) and used for defining the common reference frame. For example, when taking a step forward, the vertical axis and common axis (i.e., “forward”) can be used to determine the third axis (i.e. “left”).

With the sensors' individual reference frames having been transformed into a common reference frame, joint sensor data can be accurately interpreted by the computing system without the need for a magnetometer in each sensor. As the subject user performs subsequent body movements, 3D motion data is generated indicating changes in the position and orientation of each sensor in the sensor array affixed to the subject user's body. Using the common reference frame, the computing system can interpret the 3D motion data from each sensor relative to the 3D motion data from the other sensors in the array, to accurately capture the subject user's motion. Additional details regarding these techniques are described in more detail below.

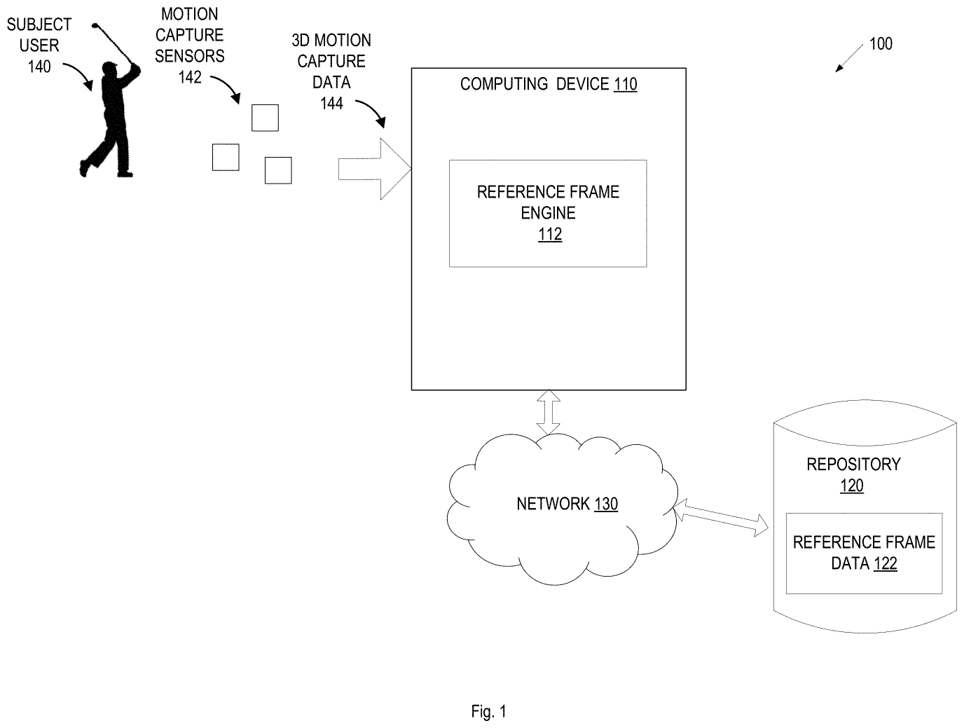

FIG. 1 depicts a high-level component diagram of an illustrative system architecture 100, in accordance with one or more aspects of the present disclosure. System architecture 100 includes a computing device 110 and a repository 120 connected to a network 130. Network 130 may be a public network (e.g., the Internet), a private network (e.g., a local area network (LAN) or wide area network (WAN)), or a combination thereof. In one embodiment, repository 120 can be directly connected to computing device 110 without an intervening network or can be contained within computing device 110.

The computing device 110 may be configured to determine a common reference frame for an array of inertial motion capture sensors 142 to avoid the negative impact of local magnetic interference and analyze 3D motion capture data received from those motion capture sensors 142. In one embodiment, computing device 110 may be a desktop computer, a laptop computer, a smartphone, a tablet computer, a server, or any suitable computing device capable of performing the techniques described herein. In one embodiment, a plurality of motion capture sensors 142, which may be affixed to one or more body parts of a subject user 140 while they are performing a physical activity, capture 3D motion capture data 144 corresponding to the subject user 140. In other embodiments, the motion capture sensors 142 may be affixed to any relevant object being manipulated by the subject user 140 while performing the physical activity, such as to a golf club, baseball bat, tennis racquet, crutches, prosthetics, etc. The 3D motion capture data 144 may be received by the computing device 110.

The 3D motion capture data 144 may be received in any suitable manner. For example, the motion capture sensors 142 may be wireless inertial sensors, each including for example, a gyroscope, magnetometer, accelerometer, and/or other components to measure sensor data including relative positional data, rotational data, and acceleration data. In one embodiment, the motion capture sensors 142 do not include a magnetometer. The 3D motion capture data 144 may include this sensor data and/or other data derived or calculated from the sensor data. The motion capture sensors 142 may transmit the 3D motion capture data 144 including, raw sensor data, filtered sensor data, or calculated sensor data, wirelessly to computing device 110 using internal radios or other communication mechanisms. In other embodiments, other systems may be used to capture 3D motion capture data 144, such as an optical system, using one or more cameras, a mechanical motion system, an electro-magnetic system, an infra-red system, etc. In addition, in other embodiments, the 3D motion capture data 144 may have been previously captured and stored in a database or other data store. In this embodiment, computing device 110 may receive the 3D motion capture data 144 from another computing device or storage device where the 3D motion capture data 144 is maintained. In still other embodiments, the 3D motion capture data 144 may be associated with one or more other users besides or in addition to subject user 140 performing the physical activity.

The 3D motion capture data 144 can be captured by motion capture sensors 142 while the subject user 140 is performing the physical activity. The physical activity can be for example, swinging a golf club, throwing a ball, running, walking, jumping, sitting, standing, or any other physical activity. When performing the physical activity, the subject user 140 may make one or more body movements that together enable performance of the physical activity. For example, when swinging a golf club, the user may rotate their hips and shoulders, swing their arms, hinge their wrists, etc., each of which can be considered a separate body movement associated with performing the physical activity. Each physical activity may have its own unique set of associated body movements.

In one embodiment, computing device 110 may include a reference frame engine 112. The reference frame engine 112 may include instructions stored on one or more tangible, machine-readable storage media of the computing device 110 and executable by one or more processing devices of the computing device 110. In one embodiment, reference frame engine 112 performs an initial calibration routine for the array of motion capture sensors 142. In one embodiment, reference frame engine 112 disables the magnetometer of each of the motion capture sensors 142 (if present) and receives information (e.g., user input) indicating the position of each motion capture sensor 142. For example, the user input can indicate an approximate placement of each motion capture sensor 142, such as on the chest, arm, pelvis, leg, etc. of subject user 140. The precise orientation of each motion capture sensor 142 relative to others in the array is not known, however. Thus, each motion capture sensor 142 has its own reference frame (i.e., 3-axis coordinate system), which may be misaligned.

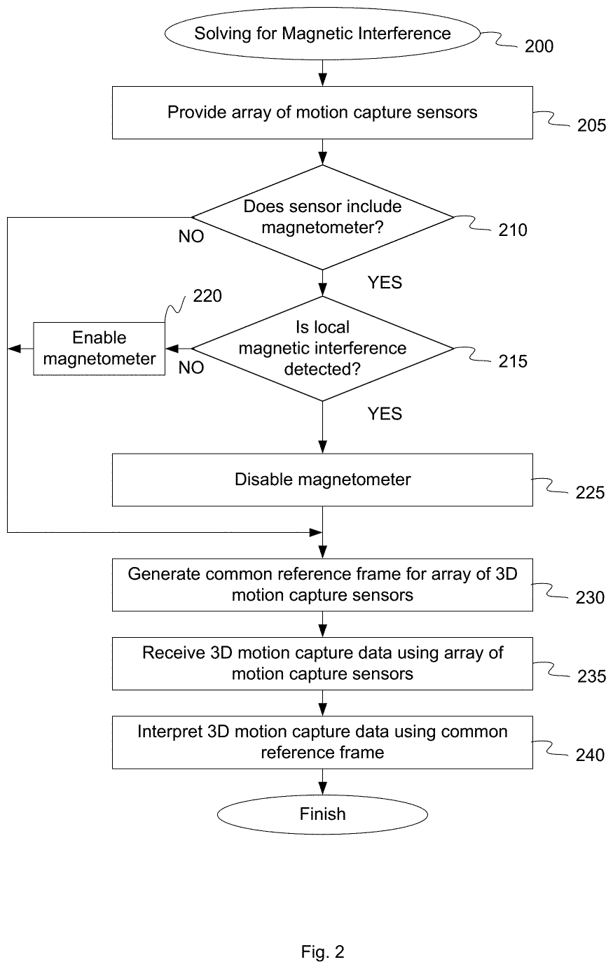

As part of the initial calibration routine, reference frame engine 112 can develop a common reference frame that aligns the individual references frames of each motion capture sensor 142. The relative orientation of each sensor can then be analyzed using this common reference frame. In one embodiment, one of the axes in the common reference frame (e.g., the z-axis) will coincide with the physical up and down (i.e., vertical) direction. This information can be determined from the captured sensor data, such as by applying a Kalman-filter to the accelerometer and gyroscope data. The output of the accelerometer is a 3D vector, which represents the net of acceleration forces affecting the sensor. When the sensor is stationary, this vector will point in the direction of gravity, which we understand as the “down” direction. If the sensor is not completely stationary, such as if it is applied to a person's body which tends to move even slightly, the Kalman filter can be applied to data from the gyroscope. Multiple measurements of both the acceleration and the gyroscope data can be taken and combined to generate an estimation of the “up” and “down” directions. The other two axes (e.g., the x-axis and the y-axis) may be different for different motion capture sensors 142. Reference frame engine 112 can perform a transformation to rotate any sensor's individual reference frame to align with any other sensor's individual reference frame by a rotation around the vertical axis to generate the common reference frame. Additional details of this transformation and other operations performed by reference frame engine 112 are described below with respect to FIGS. 2-6. In one embodiment, 3D motion capture data 144, data representing the individual reference frames of motion capture sensors 142, and data representing the generated common reference frame can be stored as part of reference frame data 122 in repository 120.

The repository 120 is a persistent storage device that is capable of storing reference frame data 122 and/or other data, as well as data structures to tag, organize, and index this data. Repository 120 may be hosted by one or more storage devices, such as main memory, magnetic or optical storage based disks, tapes or hard drives, NAS, SAN, and so forth. Although depicted as separate from the computing device 110, in an implementation, the repository 120 may be part of the computing device 110 or may be directly attached to computing device 110. In some implementations, repository 120 may be a network-attached file server, while in other embodiments, repository 120 may be some other type of persistent storage such as an object-oriented database, a relational database, and so forth, that may be hosted by a server machine or one or more different machines coupled to the via the network 130.

FIG. 2 is a flow diagram illustrating method of solving magnetic interference in inertial sensors in accordance with one or more aspects of the present disclosure. The method 200 may be performed by processing logic that comprises hardware (e.g., circuitry, dedicated logic, programmable logic, microcode, etc.), software (e.g., instructions run on a processor to perform hardware simulation), firmware, or a combination thereof. In one embodiment, method 200 may be performed by computing device 110 including reference frame engine 112, as shown in FIG. 1.

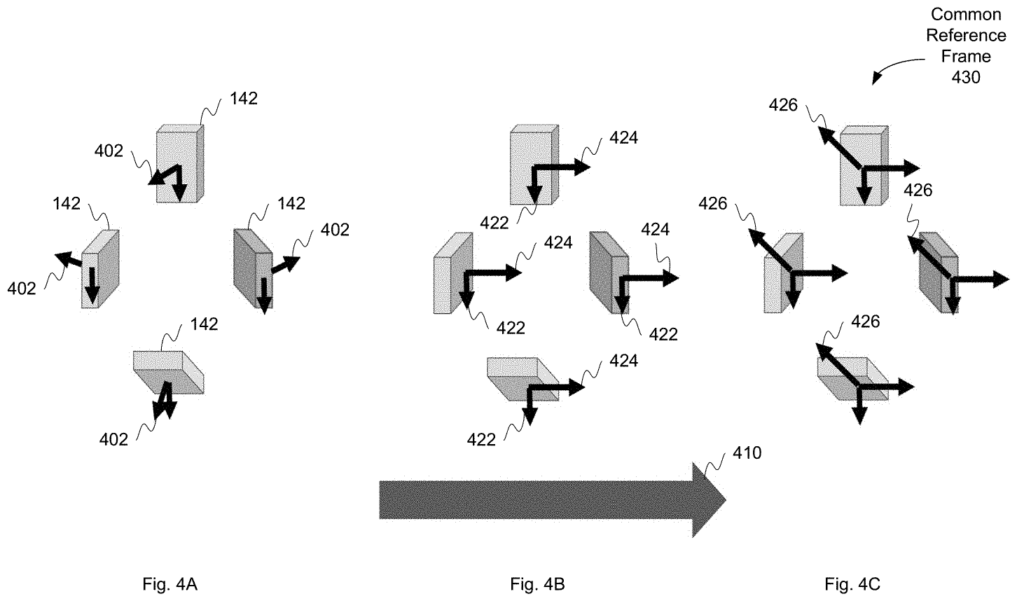

Referring to FIG. 2, at block 205, the processing logic provides a plurality of motion capture sensors 142 affixed to different portions of a subject, such as the body of subject user 140, or some other object being manipulated by the subject user 140, such as a golf club, baseball bat, tennis racquet, crutches, prosthetics, etc. In one embodiment, the plurality of motion capture sensors comprises inertial sensors. The motion capture sensors 142 work together to capture 3D motion data and provide that data to computing device 110 for analysis. In one embodiment, there is an array of motion capture sensors 142, including two or more inertial sensors affixed to different portions of the subject. Separate 3D motion data captured from each of the motion captures sensors 142 can be combined and/or interpreted together to represent a movement of the subject. FIG. 4A illustrates an array of multiple motion capture sensors 142. As each sensor is affixed to a different portion of the subject, each sensor (or at least one or more sensors) generally has a different orientation relative to the other sensors. Thus, each sensor can have a separate individual reference frame 402. Although one or more of the individual reference frames 402 may align coincidentally, it is unlikely that all of the individual reference frames 402 will align. Without a functioning magnetometer, such as if a magnetometer is not present or if it is impacted by local magnetic interference, there is no common reference frame shared by all of the motion capture sensors 142. Accordingly the 3D motion data from the motion capture sensors 142 cannot be accurately interpreted together.

Referring again to FIG. 2, at block 210, the processing logic determines whether the plurality of motion capture sensors 142 includes a magnetometer. In one embodiment, each of the motion capture sensors 142 includes an accelerometer, a gyroscope, and a magnetometer, among other components. In another embodiment, one or more of the inertial sensors do not include a magnetometer, relying instead of data from the accelerometer and gyroscope. In one embodiment, reference frame engine 112 receives user input, such as from the subject user 140 or from some other technician or individual, indicating which sensors in the array of motion capture sensors 142 includes a magnetometer. In another embodiment, reference frame engine 112 receives registration information pertaining to the motion capture sensors 142 (e.g., a unique identifier, model number, etc.) and cross-references that registration information with a database to determine whether a magnetometer is included. In another embodiment, reference frame engine receives 3D motion data from the motion capture sensors 142 and determines whether the received data includes a magnetic component.

In response to the plurality of motion capture sensors 142 including a magnetometer, at block 215, the processing logic determines whether local magnetic interference is detected. In one embodiment, reference frame engine 112 receives user input, such as from the subject user 140 or from some other technician or individual, indicating whether a possible source of local magnetic interference is present. For example if the array of motion capture sensors 142 is being used in the vicinity of large machines or other metal objects that may have become magnetized, the user can indicate the presence of local magnetic interference. In another embodiment, the motion capture sensors 142 can detect the presence of local magnetic interference themselves, and provide a notification of such to reference frame engine 112. Local magnetic interference can disrupt the operation of the magnetometer in the motion capture sensors 142, resulting in incorrect or inaccurate 3D motion capture data. Magnetometers detect the direction and strength of the local magnetic field. When there is no magnetic interference, the output of the magnetometer points towards the Magnetic North, within a specified strength range. As the sensor's physical orientation changes, the estimation of the direction of Magnetic North in a global reference frame is computable, and will generally remain stay constant. In the presence of magnetic interference, however, the reported direction of Magnetic North it will change. In addition, a magnitude (i.e. the measured magnetic field's strength) of the magnetometer's output will possibly change as well.

In response to local magnetic interference not being detected, at block 220, the processing logic enables the magnetometer in the plurality of motion capture sensors 142. In one embodiment, the magnetometer is enabled by default, so reference frame engine 112 simply allows the magnetometer to remain enabled and to be used during sensing operations. In another embodiment, reference frame engine 112 can actively enable the magnetometer, such as by sending a corresponding command to the motion capture sensors 142.

In response to local magnetic interference being detected, at block 225, the processing logic disables the magnetometer in the plurality of motion capture sensors. In one embodiment, the magnetometer is disable by default, so reference frame engine 112 simply allows the magnetometer to remain disable and not used during sensing operations. In another embodiment, reference frame engine 112 can actively disable the magnetometer, such as by sending a corresponding command to the motion capture sensors 142.

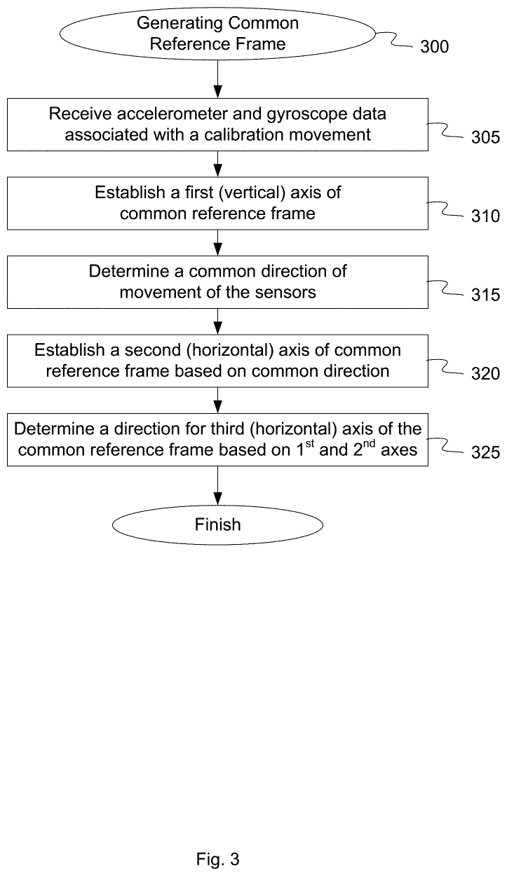

At block 230, the processing logic generates, without using a magnetometer, a common reference frame for the plurality of motion capture sensors 142. In one embodiment, if magnetometers are present in the motion capture sensors 142 and are enabled, the common reference frame can be a global reference frame. Data from the magnetometers allows reference frame engine 112 to determine a precise orientation of each motion capture sensor 142 including what direction each motion capture sensor 142 is pointed. Accordingly, a global reference frame can be used, such as a coordinate system, where one axis points due north, a second axis is vertical from the ground, and a third axis is orientated at 90 degrees to the first and second axes. If, however, magnetometers are not present or are disabled, reference frame engine 112 can generate a new common reference frame, such as common reference frame 430 illustrated in FIG. 4C. In one embodiment, establishing the common reference frame 430 for the plurality of motion capture sensors 142 comprises transforming a plurality of individual reference frames 402 corresponding to the plurality of motion capture sensors 142 into the common reference frame 430. A detailed explanation of how the common reference frame 430 is generated is provided below with respect to FIG. 3.

At block 235, the processing logic receives, from the plurality of motion capture sensors 142, 3D motion capture data 144 corresponding to a movement of the subject. In one embodiment, the 3D motion capture data 144 includes data representing one or more motions associated with performing the movement. In one embodiment, computing device 110 receives the 3D motion capture data 144 from the motion capture sensors 142 over a wireless communication link (e.g., Bluetooth). In other embodiments, the 3D motion capture data 144 may have been previously captured and stored in a database or other data store, such as repository 120. In one embodiment, the 3D motion capture data 144 is accompanied by a request or instruction to perform a physical movement analysis. The request may be received from a user of computing device 110, from a user of a client device coupled to computing device 110 via network 130, or from some other requestor. In one embodiment, reference frame engine 112 receives the 3D motion capture data 144 and stores the 3D motion capture data 144 in repository 120 as part of reference frame data 122.

At block 240, the processing logic interprets, using the common reference frame 430, the 3D motion capture data 144 from the plurality of motion capture sensors 142 to represent the movement of the subject. In one embodiment, interpreting the 3D motion capture data includes determining changes in position, orientation, rotation, acceleration, etc. of each of the motion capture sensors 142 based on the 3D motion capture data 144. Since the 3D motion capture data is interpreted in the common reference frame 430, the movement of one sensor can be accurately determined relative to the remaining sensors in the array. Reference frame engine 112 or some other component or application of computing device 110 can perform any number of analyses on the 3D motion capture data. For example, reference frame engine 112 can generate a three dimensional (3D) visualization comprising a virtual avatar illustrating the movement of the subject. In one embodiment, the 3D visualization is based on 3D motion capture data 144 corresponding to subject user 140 performing a physical activity. The 3D motion capture data 144 can include one or more of positional data, rotational data, or acceleration data measured by a plurality of motion capture sensors 142. In another analysis, reference frame engine can determine a range motion or function movement data of subject user 140. The range of motion may define, for example, how far the subject user 140 can rotate a particular joint, and the functional movement data may indicate, for example, how well the subject user 140 can perform certain standardized body movements. Numerous other analyses are possible.

FIG. 3 is a flow diagram illustrating method of generating a common reference frame for an array of inertial sensors in accordance with one or more aspects of the present disclosure. The method 300 may be performed by processing logic that comprises hardware (e.g., circuitry, dedicated logic, programmable logic, microcode, etc.), software (e.g., instructions run on a processor to perform hardware simulation), firmware, or a combination thereof. In one embodiment, method 300 may be performed by computing device 110 including reference frame engine 112, as shown in FIG. 1.

Referring to FIG. 3, at block 305, the processing logic receives, from the plurality of motion capture sensors, accelerometer and gyroscope data associated with a calibration movement of the subject. In one embodiment, the subject performs a predefined calibration movement with the motion capture sensors 142 affixed at certain locations, which results in each of the motion capture sensors 142 moving in approximately the same direction, such as direction 410, as illustrated in FIG. 4B. For example, subject user 140 may take a few steps forward, sideways or backward. In other embodiments, other calibration movements are used. In general, any movement in which each of the motion capture sensors 142 move approximately the same amount, in the same direction, and at the same speed will suffice.

At block 310, the processing logic establishes a first axis 422 of the common reference frame based on a vertical direction, as illustrated in FIG. 4B. In one embodiment, data received from motion capture sensors 142 includes an output of the accelerometer. This output can be a 3D vector, which represents the net of acceleration forces affecting the sensor. When the sensor is stationary, this vector will point in the direction of gravity, which reference frame engine 112 can interpret as the “down” direction. Accordingly, the first axis 422 can corresponding to the direction of gravity, which will be common for all of the motion capture sensors 142.

At block 315, the processing logic determines, from the accelerometer and gyroscope data, a common direction of movement 410 of the motion capture sensors 142 associated with the calibration movement. The calibration movement allows reference frame engine 112 to determine a common direction of movement for the multiple motion capture sensors 142 based on accelerometer and gyroscope data received from the motion capture sensors 142. In one embodiment, the common direction is a 3D vector for each sensor, interpreted in that sensor's individual reference frame that coincides with the same physical direction (i.e., direction 410). At block 320, the processing logic establishes a second axis 424 of the common reference frame based on the common direction of movement 410.

At block 325, the processing logic determines a direction for a third axis 426 of the common reference frame 430 based on the first axis 422 and the second axis 424. When the individual reference frame of two sensors is different, the 3D vector will be numerically different for each sensor. The vector, however, will be perpendicular to the vertical axis established at block 305, which is shared in common by all of motion capture sensors 142. The “down” direction (i.e., along the vertical z-axis) and “common” direction (i.e., in the direction of the common movement) can be used to determine the third direction. In one embodiment, the direction for the third axis 426 is set at a 90 degree angle to each of the first two directions.

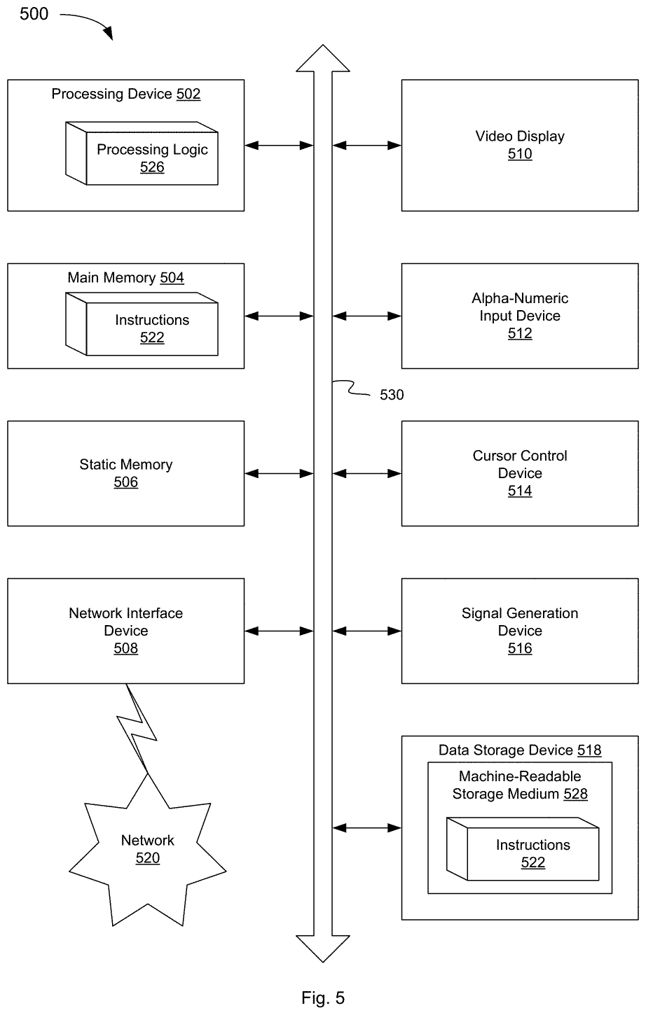

FIG. 5 depicts an example computer system 500 which can perform any one or more of the methods described herein, in accordance with one or more aspects of the present disclosure. In one example, computer system 500 may correspond to a computing device, such as computing device 110, capable of executing reference frame engine 112 of FIG. 1. The computer system 500 may be connected (e.g., networked) to other computer systems in a LAN, an intranet, an extranet, or the Internet. The computer system 500 may operate in the capacity of a server in a client-server network environment. The computer system 500 may be a personal computer (PC), a tablet computer, a set-top box (STB), a personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 500 includes a processing device 502, a main memory 504 (e.g., read-only memory (ROM), flash memory, dynamic random access memory (DRAM) such as synchronous DRAM (SDRAM)), a static memory 506 (e.g., flash memory, static random access memory (SRAM)), and a data storage device 518, which communicate with each other via a bus 530.

Processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute instructions for performing the operations and steps discussed herein.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker). In one illustrative example, the video display unit 510, the alphanumeric input device 512, and the cursor control device 514 may be combined into a single component or device (e.g., an LCD touch screen).

The data storage device 518 may include a computer-readable medium 528 on which the instructions 522 (e.g., implementing reference frame engine 112) embodying any one or more of the methodologies or functions described herein is stored. The instructions 522 may also reside, completely or at least partially, within the main memory 504 and/or within the processing device 502 during execution thereof by the computer system 500, the main memory 504 and the processing device 502 also constituting computer-readable media. The instructions 522 may further be transmitted or received over a network via the network interface device 508.

While the computer-readable storage medium 528 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “setting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any procedure for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method comprising:
providing a plurality of motion capture sensors affixed to different portions of a subject;
generating, by a processing device and without using a magnetometer, a common reference frame for the plurality of motion capture sensors;
receiving, from the plurality of motion capture sensors, three dimensional (3D) motion capture data corresponding to a movement of the subject; and
interpreting, using the common reference frame, the 3D motion capture data from the plurality of motion capture sensors to represent the movement of the subject.

2. The method of claim 1, wherein the plurality of motion capture sensors comprises inertial sensors.

3. The method of claim 1, further comprising:
determining whether the plurality of motion capture sensors includes the magnetometer; and
in response to the plurality of motion capture sensors including the magnetometer, determining whether local magnetic interference is detected.

4. The method of claim 3, further comprising:
in response to local magnetic interference being detected, disabling the magnetometer in the plurality of motion capture sensors.

5. The method of claim 3, further comprising:
in response to local magnetic interference not being detected, enabling the magnetometer in the plurality of motion capture sensors.

6. The method of claim 1, wherein generating the common reference frame for the plurality of motion capture sensors comprises transforming a plurality of individual reference frames corresponding to the plurality of motion capture sensors into the common reference frame.

7. The method of claim 6, wherein transforming the plurality of individual reference frames into the common reference frame comprises:
receiving, from the plurality of motion capture sensors, accelerometer and gyroscope data associated with a calibration movement of the subject;
establishing, based on the accelerometer and gyroscope data, a first axis of the common reference frame based on a vertical direction;
determining, from the accelerometer and gyroscope data, a common direction of movement of the motion capture sensors associated with the calibration movement;
establishing a second axis of the common reference frame based on the common direction of movement; and
determining a direction for a third axis of the common reference based on the first axis and the second axis.

8. A system comprising:
a memory device storing instructions;
a processing device coupled to the memory device, the processing device to execute the instructions to perform operations comprising:
providing a plurality of motion capture sensors affixed to different portions of a subject;
generating, without using a magnetometer, a common reference frame for the plurality of motion capture sensors;
receiving, from the plurality of motion capture sensors, three dimensional (3D) motion capture data corresponding to a movement of the subject; and
interpreting, using the common reference frame, the 3D motion capture data from the plurality of motion capture sensors to represent the movement of the subject.

9. The system of claim 8, wherein the plurality of motion capture sensors comprises inertial sensors.

10. The system of claim 8, wherein the processing device to execute the instructions to perform further operations comprising:
determining whether the plurality of motion capture sensors includes the magnetometer; and
in response to the plurality of motion capture sensors including the magnetometer, determining whether local magnetic interference is detected.

11. The system of claim 10, wherein the processing device to execute the instructions to perform further operations comprising:
in response to local magnetic interference being detected, disabling the magnetometer in the plurality of motion capture sensors.

12. The system of claim 10, wherein the processing device to execute the instructions to perform further operations comprising:
in response to local magnetic interference not being detected, enabling the magnetometer in the plurality of motion capture sensors.

13. The system of claim 8, wherein generating the common reference frame for the plurality of motion capture sensors comprises transforming a plurality of individual reference frames corresponding to the plurality of motion capture sensors into the common reference frame.

14. The system of claim 13, wherein transforming the plurality of individual reference frames into the common reference frame comprises:
receiving, from the plurality of motion capture sensors, accelerometer and gyroscope data associated with a calibration movement of the subject;
establishing, based on the accelerometer and gyroscope data, a first axis of the common reference frame based on a vertical direction;
determining, from the accelerometer and gyroscope data, a common direction of movement of the motion capture sensors associated with the calibration movement;
establishing a second axis of the common reference frame based on the common direction of movement; and
determining a direction for a third axis of the common reference based on the first axis and the second axis.

15. A non-transitory computer-readable storage medium storing instructions that, when executed by a processing device, cause the processing device to perform operations comprising:
providing a plurality of motion capture sensors affixed to different portions of a subject;
generating, without using a magnetometer, a common reference frame for the plurality of motion capture sensors;
receiving, from the plurality of motion capture sensors, three dimensional (3D) motion capture data corresponding to a movement of the subject; and
interpreting, using the common reference frame, the 3D motion capture data from the plurality of motion capture sensors to represent the movement of the subject.

16. The non-transitory computer-readable storage medium of claim 15, further comprising:
determining whether the plurality of motion capture sensors includes the magnetometer; and
in response to the plurality of motion capture sensors including the magnetometer, determining whether local magnetic interference is detected.

17. The non-transitory computer-readable storage medium of claim 16, further comprising:
in response to local magnetic interference being detected, disabling the magnetometer in the plurality of motion capture sensors.

18. The non-transitory computer-readable storage medium of claim 16, further comprising:
in response to local magnetic interference not being detected, enabling the magnetometer in the plurality of motion capture sensors.

19. The non-transitory computer-readable storage medium of claim 15, wherein generating the common reference frame for the plurality of motion capture sensors comprises transforming a plurality of individual reference frames corresponding to the plurality of motion capture sensors into the common reference frame.

20. The non-transitory computer-readable storage medium of claim 19, wherein transforming the plurality of individual reference frames into the common reference frame comprises:
receiving, from the plurality of motion capture sensors, accelerometer and gyroscope data associated with a calibration movement of the subject;
establishing, based on the accelerometer and gyroscope data, a first axis of the common reference frame based on a vertical direction;
determining, from the accelerometer and gyroscope data, a common direction of movement of the motion capture sensors associated with the calibration movement;
establishing a second axis of the common reference frame based on the common direction of movement; and
determining a direction for a third axis of the common reference based on the first axis and the second axis.
